(19) United States
(12) Patent Application Publication
(10) Pub. No.: US 2013/0173360 A1
(43) Pub. Date: Jul. 4, 2013

(54) METHODS OF ALLOCATING BENEFITS RECEIVED IN RESPONSE TO GENERATING ENERGY WITHIN COMMUNITIES TO COMMUNITY INTERESTS

(71) Applicant: Robert Thatcher, Lake Oswego, OR (US)

(72) Inventor: Robert Thatcher, Lake Oswego, OR (US)

(21) Appl. No.: 13/719,086

(22) Filed: Dec. 18, 2012

Related U.S. Application Data
(60) Provisional application No. 61/581,455, filed on Dec. 29, 2011.

(51) Int. Cl. G06Q 30/02

(52) U.S. Cl. CPC G06Q 30/0207
USPC 705/14.1

(57) ABSTRACT

Methods of allocating benefits received in response to generating energy within communities to community interests, including deploying energy generating equipment on properties of host community members, delivering delivered portions of the energy generated by the energy generating equipment to host community members, receiving community members, or power grids, measuring the delivered portions of the energy to produce measurements, receiving benefits associated with purchasing the energy generating equipment or generating energy with the energy generating equipment, the benefits defining amounts calculated based on the measurements, distributing portions of the benefit to community interests. In some examples, a community portion of the energy may be donated to community interest organizations. In some examples, benefits may define government subsidies. In some examples, marketing materials may be delivered from non-profit entities. In some examples, community members may select to participate in the community power programs on forms provided to the community members.

### CROSS REFERENCE TO RELATED APPLICATIONS

This application claims priority to copending U.S. Application Ser. No. 61/581,455, filed on Dec. 29, 2011, which is hereby incorporated by reference for all purposes.

### BACKGROUND

The present disclosure relates generally to methods of allocating benefits received in response to generating energy within communities to community interests. Some examples of such methods may include community power programs that administer the transfers of benefits.

Known renewable power programs are not entirely satisfactory for the range of applications in which they are employed. For example, many known renewable power programs are organized as Feed In Tariffs or Solar Power Purchasing Agreements (“SPPAs”), or other similar programs. SPPAs allocate benefits, which are received from using photovoltaic energy generating equipment, among providers and investors, and forward a portion of these benefits on to consumers in the form of a discounted per unit price of energy generated with associated equipment. While SPPAs provide financial structures that make solar equipment purchases more palatable to consumers, they clearly do not go far enough. For example, many communities do not develop solar projects despite these programs, even when they are able and there exist government mandates for certain states to generate a selected percentage of their energy from renewable sources. Existing programs often direct benefits accrued from the use of renewable energy generating equipment to providers and investors who bear little to no relation to the communities where the energy is being generated. These benefits are often used to generate profits for the interested parties. Further, benefits derived from many existing energy distribution systems benefit only individuals, rather than directing a portion of both environmental and financial benefits received in association with generating renewable energy to the greater community to which the individuals belong.

This produces an unbalanced value proposition to consumers that hinders renewable energy development. By providing little to no tangible benefit to communities of energy generating community members beyond the individuals hosting energy generating equipment, existing programs often do adequately take advantage of the potential benefit of incentivized communities or members thereof developing renewable energy programs.

As a result, there exists a need for power programs that adjust the value proposition afforded to consumers by providing tangible benefits to the consumers' communities.

### SUMMARY

The present disclosure is directed to methods of allocating benefits received in response to generating energy within communities to community interests, including deploying energy generating equipment on properties of host community members, delivering delivered portions of the energy generated by the energy generating equipment to host community members, receiving community members, or power grids, measuring the delivered portions of the energy to produce measurements, receiving benefits associated with purchasing the energy generating equipment or generating energy with the energy generating equipment, the benefits defining amounts calculated based on the measurements, distributing portions of the benefit to community interests. In some examples, a community portion of the energy may be donated to community interest organizations. In some examples, benefits may define government subsidies. In some examples, marketing materials may be delivered from non-profit entities. In some examples, community members may select to participate in the community power programs on forms provided to the community members.

### BRIEF DESCRIPTION OF THE DRAWINGS

FIG. 1 is a flow diagram illustrating relationships amongst parties of a first example of a community power program.

FIG. 2 is a flow diagram illustrating a first example of a method of allocating benefits from energy generated within a community to a community interest.

FIG. 3 is a schematic view showing relationships amongst a portion of the parties in the community power program shown in FIG. 1.

FIG. 4 is an illustration of an example of a statement from a solar provider illustrating an example of a community power program participation entry.

FIG. 5 is a flow diagram illustrating relationships amongst parties of a second example of a community power program.

FIG. 6 illustrates an organizational scheme for a third example of a community power program.

FIG. 7 illustrates an example of a statement from an example utility participating in a community power program.

FIG. 8 is a schematic view of an example of a programmable computing device for carrying out electronic metering, communication, and user-interactive features of disclosed community power programs.

### DETAILED DESCRIPTION

The disclosed programs and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various programs and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

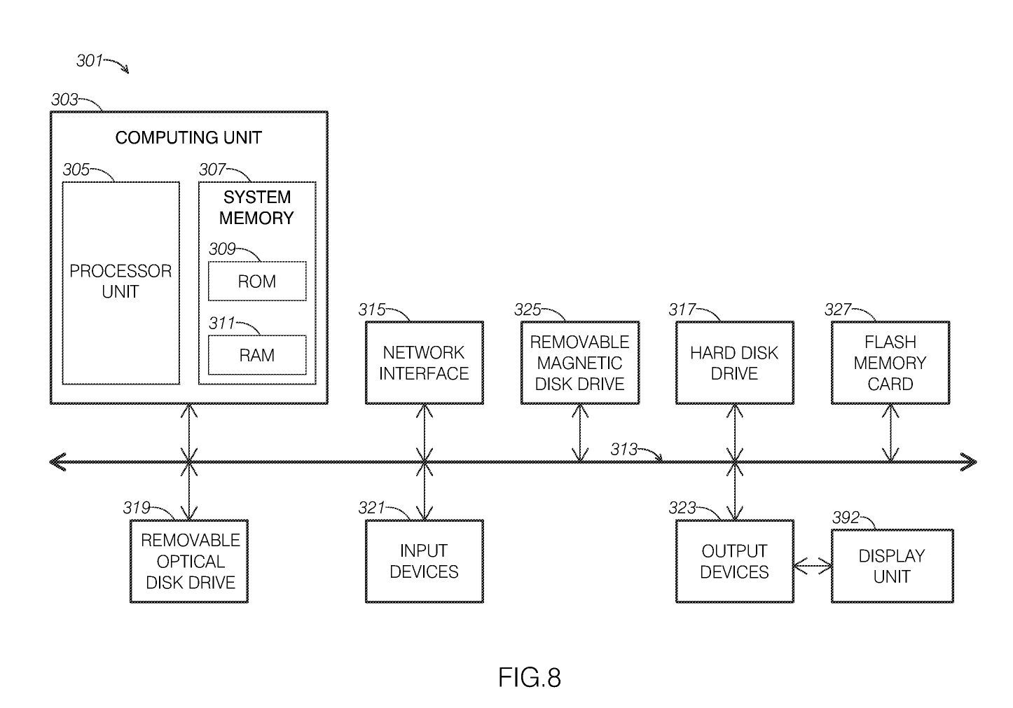

Accordingly, FIG. 8 shows one illustrative example of a computer 301 that can be used to implement various embodiments of the invention. Computer 301 may be incorporated within a variety of consumer electronic devices, such as personal media players, cellular phones, smart phones, personal data assistants, global positioning system devices, and the like.

As seen in this figure, computer 301 has a computing unit 303. Computing unit 303 typically includes a processing unit 305 and a system memory 307. Processing unit 305 may be any type of processing device for executing software instructions, but will conventionally be a microprocessor device. System memory 307 may include both a read-only memory (ROM) 309 and a random access memory (RAM) 311. As will be appreciated by those of ordinary skill in the art, both read-only memory (ROM) 309 and random access memory (RAM) 311 may store software instructions to be executed by processing unit 305.

Processing unit 305 and system memory 307 are connected, either directly or indirectly, through a bus 313 or alternate communication structure to one or more peripheral devices. For example, processing unit 305 or system memory 307 may be directly or indirectly connected to additional memory storage, such as a hard disk drive 317, a removable optical disk drive 319, a removable magnetic disk drive 325, and a flash memory card 327. Processing unit 305 and system memory 307 also may be directly or indirectly connected to one or more input devices 321 and one or more output devices 323. Input devices 321 may include, for example, a keyboard, touch screen, a remote control pad, a pointing device (such as a mouse, touchpad, stylus, trackball, or joystick), a scanner, a camera or a microphone. Output devices 323 may include, for example, a monitor display, an integrated display, television, printer, stereo, or speakers.

Still further, computing unit 303 will be directly or indirectly connected to one or more network interfaces 315 for communicating with a network. This type of network interface 315, also sometimes referred to as a network adapter or network interface card (NIC), translates data and control signals from computing unit 303 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 315 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 301 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 301 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 301 so that their data maintained may be synchronized.

Of course, still other peripheral devices may be included with or otherwise connected to a computer 301 of the type illustrated in FIG. 8, as is well known in the art. In some cases, a peripheral device may be permanently or semi-permanently connected to computing unit 303. For example, with many computers, computing unit 303, hard disk drive 317, removable optical disk drive 319 and a display are semi-permanently encased in a single housing.

Still other peripheral devices may be removably connected to computer 301, however. Computer 301 may include, for example, one or more communication ports through which a peripheral device can be connected to computing unit 303 (either directly or indirectly through bus 313). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 301 may include a wireless data “port,” such as a Bluetooth® interface, a Wi-Fi interface, an infrared data port, or the like.

It should be appreciated that a computing device employed according various examples of the invention may include more components than computer 301 illustrated in FIG. 8, fewer components than computer 301, or a different combination of components than computer 301. Some implementations of the invention, for example, may employ one or more computing devices that are intended to have a very specific functionality, such as a digital music player or server computer. These computing devices may thus omit unnecessary peripherals, such as the network interface 315, removable optical disk drive 319, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

This disclosure is directed to methods of allocating benefits from energy generated from community power programs to community interests or community interest organizations. These programs may, for example, lead to the development of renewable or other alternative energy power projects, such as those implementing fuel cell technologies, in communities that take advantage of directing to community interests a portion of benefits received in association with the renewable projects and energy generated therefrom. For example, community power programs may direct a portion of benefits received in response to community members' generating renewable power. In particular, members of the community may host renewable energy generating equipment, such as solar panels, on their property. In exchange for either hosting the equipment or generating energy therewith, hosts (or other members of the community power program) often accrue benefits, such as energy credits, beneficial tax treatment, or rebates. In some cases, hosts may receive energy credits that are reflective of the amount of energy they generated; these energy credits may be transferred to other parties to, in effect, transfer the power generated by a host to another party. Community power programs may direct these benefits to community interests or community interest organizations. Further, community power programs may, in effect, provide community interests with generated energy, by directing energy credits reflective of the hosts energy generation to community interest organizations or separate receiver entities.

In some examples, hosts or communities may enter SPPAs with solar providers, utilities, or special purpose entities. In these SPPAs, the hosts or communities enter into an agreement to pay for their use of renewable energy generated by renewable energy generating equipment at a price that is discounted to reflect the benefits received for the renewable energy production. In many cases, hosts receive their share of generated energy in the form of energy credits, which are applied to their energy bill. In such examples, hosts often satiate substantially all of their energy consumption with grid energy and apply the received energy credits to their resulting energy bill.

Unlike many existing SPPAs, however, disclosed community power programs may direct benefits, including these generated energy credits, to community interests. Often this occurs by directing the benefits to community interest organizations or separate receiver entities organized to distribute the benefits to community interests. In many cases, the combined effect of the community may, in effect, provide sufficient power to satiate entire community interest organizations' energy consumption through each participating community member donating to community interest organizations a portion of benefits, including energy credits, received in exchange for generating energy with energy generating equipment.

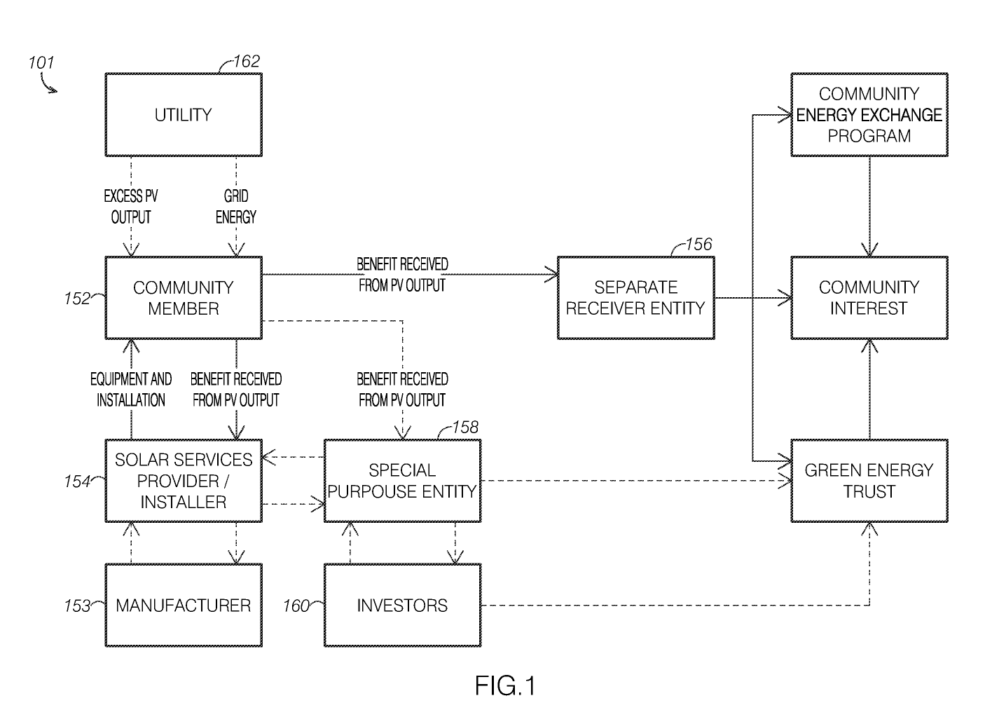

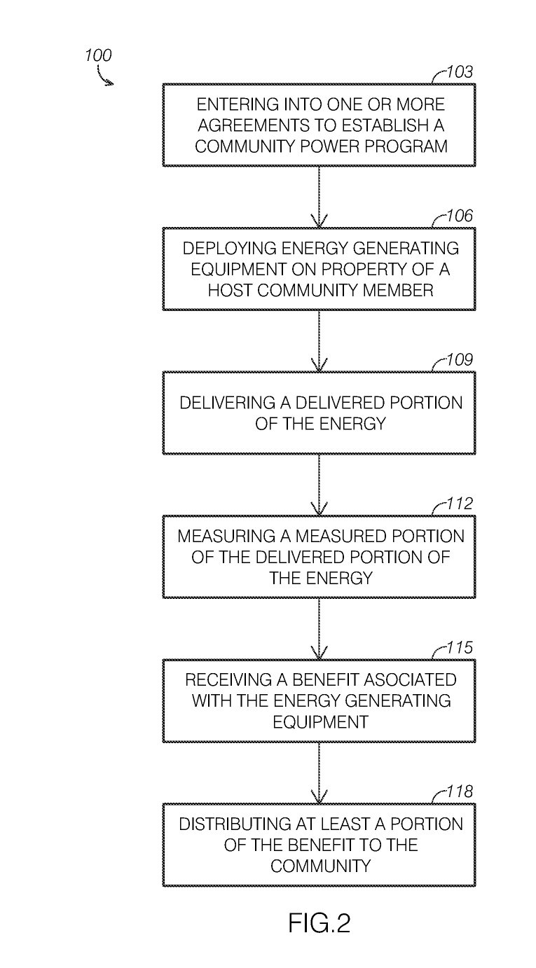

With reference to FIGS. 1-4, a first example of a method of allocating benefits from energy generated within a community to a community interest, method 100, will now be described. As FIG. 2 illustrates, method 100 includes entering into one or more agreements to establish a community power program at step 103, deploying energy generating equipment on property of a community member at step 106, delivering a delivered portion of the energy at step 109, measuring a measured portion of the delivered portion of the energy at step 112, receiving a benefit associated with the energy generating equipment at step 115, and distributing at least a portion of the benefit to the community at step 118. Method 100, and other associated examples, are elaborated in fairly extensive terms, including many features that may not be necessary in each and every community power program or method implementing the same.

Many disclosed examples describe communities including community members. Although no specific communities are illustrated, communities typically include a group of community members that share a common interest. In some examples, communities may be defined by geographic proximity, such as a neighborhoods or geographic areas. Similarly, communities may be defined by governmental designations, such as cities, towns, counties, states, school districts, etc. Some examples of communities, however, are defined solely or partially by a shared interest. For example, certain communities may define interest groups with memberships that define disparate locations while each share an interest in a common community interest. These interest groups support charitable causes or public development. In some examples, communities may define residences within a school district that includes one or more local schools.

Community power programs that do have memberships that share geographic proximity to one another may provide some unique benefits, however. Some communities may include members that lack sufficient space and exposure to sunlight to generate solar power. As a result, several community members may have inadequate means to take advantage of the benefits associated with installing and using renewable energy generating equipment, though they are willing and interested in doing so.

Because community power programs direct a portion of benefits associated with community-generated renewable energy to community interests, community power programs provide incentives for communities at large, including the non-generating members. This may lead non-generating members to spur renewable energy development in their community, even when unable to generate renewable energy themselves. They may spur development in softer ways, like convincing neighbors to host energy generating equipment on their property, or in more concrete ways, like developing community organizations directed to renewable energy development in their community.

The disclosed methods may direct benefits received from community members' use of renewable energy generating equipment, such as photovoltaic panels or wind turbines, to community interests and community interest organizations. As previously discussed, these benefits may include energy credits that are merely reflective of host community members generated energy. As will be discussed below, the benefits may further include other benefits received for generating renewable or alternative energy. Because these other benefits may be donated through community power programs, community power programs may be particularly adapted to developing renewable and alternative energy programs. Community members' ability to install alternative or renewable energy generating equipment on their property without considerable regulatory hurdles makes community power programs even more adaptable to renewable and alternative energy programs. Communities, and the members thereof, may actually have property available to host renewable and alternative energy generating equipment, thereby opening up a large amount of area for energy generating projects that would not have existed before. Further, communities, or the members thereof, may have certain properties that are currently underutilized for such projects; community power programs adjust incentives such that the community members may pool together to develop such underutilized areas.

Directing benefits to community interests may produce tangible benefits within the community. For example, benefits directed to a school district or member schools may allow them to reduce their energy expenditures or support and develop after school programs and other school sponsored activities.

By directing benefits received as compensation for generating renewable energy on community properties to interests that benefit the community as a whole, community power programs are able to change the value proposition afforded by renewable energy programs while often preserving much of owners' individual benefits, such as discounted energy costs. For example, many conventional harness benefits primarily to drive investors' profits. This insufficiently incentivizes communities to collectively develop renewable energy projects. Providing stronger incentives to communities will drive them to be more willing to develop renewable energy projects, such as solar energy projects. These programs may even tilt the incentives to a tipping point where renewable energy projects become so economical as to be preferred as a mainstream alternative to non-renewable or high polluting energy sources. For instance, some examples may include deploying renewable energy generating equipment on the property one or more supplemental host community members in response to a value proposition defined by directing a portion of the benefit to a community interest or community interest organization.

Directing a portion of the benefit to community interests or community interest organizations may lead to greater installation density within associated communities. This would, in turn, drive heavy investment into local grid infrastructure, such as “smart-grid” technologies that increase the efficiency with which energy is locally distributed. Additionally or alternatively, this increased installation density may make installing local energy storage, such as batteries, both practical and commercially viable. With regard to storage specifically, the low, scattered density of installations coupled with the low volume of installations overall requires storage capacities and charge retentions that current battery technologies are currently unable to provide; the increased density and volume of installations reduce the importance of these specifications.

In some examples, a special purpose entity or host may revenue share with a utility to help mitigate the losses they experience when being forced to buy solar power at a higher rate than the resell value. This may, in some examples, operate similar to contemporary Feed-in-Tariff systems. Many Feed-in-Tariff systems, however, run in to problems resulting from utilities being forced to purchase energy from hosts of energy generating equipment (or managing special purpose entities) at rates higher than their resale value. Some examples, however, may improve upon contemporary Feed-in-Tariff systems by including a surcharge on the cost of generating equipment to pay special purpose entities, or other managing entities, in excess of operational costs. This extra revenue may be transferred to utilities to offset any losses that may occur. Because of this revenue sharing models, utilities and/or special purpose entities may be more apt to use the Feed-in-Tariff framework to help subsidize the proliferation of renewable energy generating equipment.

As FIG. 2 illustrates, one or more agreements are entered into to establish the community power program at step 103. In some examples, the agreements may collectively define a SPPA amongst several parties. FIG. 1 illustrates an example of a community power program that includes some features similar or identical to conventional SPPAs, program 101, including a host community member that contracted with a solar provider to deploy solar equipment on his property in exchange for purchasing energy generated by the solar generating equipment.

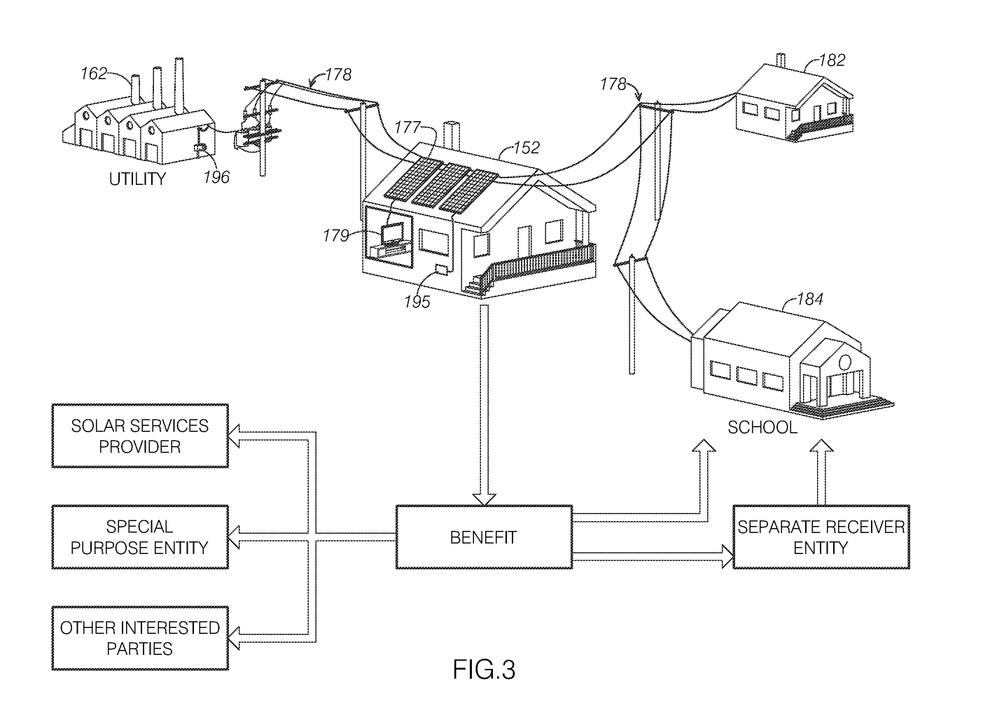

As FIG. 1, shows, parties to program 101 may include a host community member 152, a solar services provider 154, a separate receiver entity 156, a special purpose entity 158, energy equipment providers 153 (which may include manufacturers and installers), investors 160, and a utility 162. Although FIGS. 1 and 3 only illustrate a single host community member, community power programs may additionally or alternatively include one or more supplemental host community members. The SPPA governs the various parties' relationships and dictate the financial structure relating to hosts' energy generation. The SPPA can govern the flow of capital, revenue, profits, and other benefits (such as energy credits and the benefit of favorable tax treatment).

Community power programs do not necessarily need to include an SPPA similar to the one shown in FIG. 1. For clarity's sake, however, the foregoing discussion will discuss examples of community power programs that are partially governed by an SPPA similar to the one illustrated in FIG. 1. In some examples, additional or alternative agreements may also govern the parties' interests. No agreement must be formal, nor does it need to be in writing. There is no requirement for any party to contract with any other specific party.

As FIG. 2 shows, energy generating equipment is deployed on property of a host community member at step 106. In some examples, the host community member may receive energy credits in exchange for generating energy on her property, which the host community member may donate to a community interest through a community power program. In some examples, the energy generating equipment may be of a type that accrues additional or alternative benefits, such as renewable energy generating equipment, that generate additional credits or favorable tax treatment (such as renewable and/or alternative energy, such as photovoltaic cells or wind turbines). FIG. 3 diagrammatically illustrates an example where a host community member, host community member 152, has installed energy generating equipment 177 defining photovoltaic panels on his property (specifically, the roof of his residence). Renewable and/or low-pollution sources, such as solar panels or wind farms, often collect rebates, credits, favorable tax treatment, payment, or other such benefits in exchange for generating renewable energy; in some cases they may produce these benefits on a basis per unit of energy generated upon generating energy, while in other cases they may produce these benefits upon purchasing or installing the equipment.

In some cases, host community members may be local businesses or other local properties that have a large amount of area in which energy generating equipment may be installed. In addition to benefiting from directing benefits community interest as members of the community, businesses may market themselves for their participation in the program. For example, large businesses may have large surface areas exposed to the sky, such the roofs of retail spaces, warehouses, parking lots, or other such business property, that residential community members may not have available. In some examples, the benefits of participation in a community power program may entice additional businesses to operate within in the community power program's community.

As FIG. 3 illustrates, host community members, such as host community member 152, may be electrically connected to a power grid 178. Power grid 178 may connect host community member 152 to utility 162, other community members such as receiving community member 182, and community interest properties 184, such as schools, churches, government buildings, or other properties that serve a benefit to the community.

As FIG. 3 shows, host community member 152 may output energy to power grid 178. In many such cases, host community member 152 may be compensated by utility 162 for doing so. In many cases, host community members may output all of the energy generated by their energy generating equipment to the power grid. The host community member's output is metered, and another party, such as a utility or governmental entity, will provide the host community member with benefits in exchange for the generated energy.

In such examples, the host community member may be recompensed for hosting the energy generating equipment and generating energy in a number of ways. In some examples, the host community member may not pay any cost for hosting the energy generating equipment. Additionally or alternatively, host community members may receive, as a benefit, either a reduction or elimination of the price associated with the energy received from the grid. This reduced or eliminated cost may reflect the impact of subsidies, tax credits or deductions, or other benefits received by parties other than the host community member in exchange for generating energy with the energy generating equipment. These benefits are most common when host community members host energy generating equipment configured to generate alternative and/or renewable energy.

As will be discussed more later, this disclosure contemplates community power programs that may capture at least a portion of some or all of these benefits and direct them to the community benefit. In some examples, they may do so through special purpose entities or separate receiver entities organized to hold benefits and/or distribute them to community interests. For example, when energy credits, beneficial tax treatment, or other such benefits, are generated in response to generating energy using the energy generating equipment, these benefits may be directed to community interests to discount or eliminate their power expenditures. This, in effect, uses the benefits accrued by one or more host community members to power community interests. For example, host community members may receive energy at a price that is discounted to reflect benefits accrued by other parties to a SPPA, such as energy credits or beneficial tax treatment. In some such examples, this discount may be applied to community interests' power consumption rather than host community members'. This may, in effect, supply some or all of the power to community interest organizations.

In some examples, however, host community member 152 may power a portion of his own electricity requirements, such illustrated in FIG. 3 as host community member 152 is able to power electrical device 179. This disclosure notes that this may be atypical of many examples wherein one or more of the parties enter into a SPPA. This disclosure, however, explicitly considers arrangements wherein host community members use a portion of their energy generation to power onsite electric loads. In such examples, power distribution may occur in a more literal sense: unused portions of the actual energy generated by host community members' energy generating equipment may be directed, either through a direct line or through a power grid, to community interest organizations.

Because of the complexities of the power grid, the benefits of these may only appear as reduced energy consumption costs on organizations' balance sheets or power bills. The shifting of benefits, however, does, in effect, provide power to community interests. In many cases, the power generated by host community members (or other credits and other vehicles designed to capture the environmental benefit of their equipment) is directed to community interests. This, in effect, allows host community members to collectively power those organizations, even if this effect is obfuscated due to the complexity of power distribution. As a result, this disclosure specifically notes that, in many cases, the transfer of energy credits operates as a de facto transfer of energy to a recipient through the power grid.

This abstraction is often necessary due to the inherent limitations of a power grid. For example, when energy is directed to a power grid, it is very difficult (and often impossible) to ensure a host community member's generated electricity reaches a particular destination. Rather than tediously tracking a particular quantity of energy to execute such a transfer, however, “credits” or other accounting tools that reflect a party's input and/or output relative the grid may be exchanged instead. As a result, many examples according to this disclosure actually provide a way whereby community members may, in effect, power community interest organizations even if the host-generated electricity does necessarily physically travel to a particular community interest organization.

In some cases, utility 162 may perform metering (according to many known metering techniques, such as net metering) to determine the amount of energy generated by host community members. This is typically done with metering equipment, including standard metering equipment. As will be discussed in greater detail below, metering equipment may, in some examples, including a computing system that includes one or more computing features that are substantially similar to features of computer 301, described above. These computing features may provide the metering equipment with features that increase the efficiency and effectiveness with which the metering equipment may be used to implement disclosed community power programs. Parties to community power programs may then accrue corresponding net metering credits and/or energy share credits based on results of the metering. In performing the metering, utility 162 may measure the amount of energy generated by energy generating equipment 177, producing a result. In some examples, the result may reflect all of the energy generated by host community members' energy generating equipment; in others, it may reflect all of the energy generated by the host community members' energy generating equipment less the amount of grid energy used by the host community members. In examples wherein the host community member directs a portion of generated energy to power local electrical devices, this result may reflect the difference between host community member 152's energy consumption and the amount he generated with energy generating equipment 177, showing the amount of generated energy that was directed to the power grid. Often, these metering techniques are performed by utility 162.

As FIG. 3 illustrates, a host community member may have a meter, such as meter 195, installed on their property that tracks the amount of energy generated by present energy generating equipment. In other examples, the amount of energy generated with the energy generating equipment may be tracked by a meter at a utility, such as meter 196. The amount of energy generated by participants' energy generating equipment may, in these examples, be tracked, for example, by smart grid technologies. In many cases, both meter 195 and meter 196 may include computer features provided by computer hardware, such as computer 301, to display or communicate data related to energy generated in association with energy generating equipment. In some examples, host community members may use additional or alternative computers in the home that may communicate with meter 195 (or, more indirectly, with meter 196 or a utility over a computer network) to receive statistics about both their output and level of participation in a community power program. In some examples, community members may additionally or alternatively receive statistics about their neighbors' output and level of participation in a community power program, which may drive competition amongst community members. In some examples, this computer hardware may communicate with utilities, solar power providers, or special purpose entities who may use the data to determine the amount of benefits to direct to community interests.

In some example, utilities may provide benefits to host community member 152 (or another party in the community power program, on behalf of host community member 152) for generating renewable energy. Additionally or alternatively, utilities may receive benefits as a result of host community member 152 generating renewable energy. In some examples, utilities may direct benefits to other entities, such as separate receiver entities or special purpose entities, to efficiently distribute benefits to community interests. Metering devices used to measure energy in various examples are often in data communication with a utility or other entity, and may communicate results to those entities. Parties within the community power program may receive benefits in exchange for these communicated results. Any such benefits that are allocated based on metering techniques may, in example community power programs, be directed to a community interest.

In some examples, the metering system may be connected to a computing system, such as one similar to computer 301, that may, for example, display, manipulate, and communicate metered results. In some examples, the computing system may communicate the metered results to the utility or the special purpose entity, who may use the data to determine the quantity of energy or benefits to transfer to a community interest according to the community power program. In some examples, the computing system (or the meter itself) may be able to display on a display unit the amount of benefits accrued and/or transferred to the community interest on behalf of the host community member. In other examples, the amount of benefits accrued and/or transferred to the community interest on behalf of the host community member may be communicated to a public location or other community accessible location, such as by hosting a display of the benefits on a publicly accessible or community accessible web server. The publication of the amount of benefits accrued may drive competition amongst community members. This competition may, of course, lead to increases in the amount of renewable energy generated in community power programs centered on renewable energy. This competition may additionally or alternatively increase the amount of benefits directed to community interests.

In some examples, the metering results may be directed to other entities that provide benefits for generating renewable energy, such as governmental entities and private interest groups. In some examples, utilities and/or government entities may provide operating grants, surcharges, or tariffs that support the community power program.

As FIG. 1 illustrates, host community members often work with other parties to make installation quicker, easier, and more economical. For example, host community member 152 may contract with solar services provider 154 to coordinate financing, design, and construction of the energy generating equipment installed on host's property. In some examples, solar services provider 154 may interface with energy equipment providers 153, such as manufacturers, installers, or other parties that may install, service, or provide services to energy generating equipment.

In some examples, the solar service providers may integrate with manufacturers and installers to perform all of the services relating to the installation of energy generating equipment. This may produce economic benefits, which may ultimately be directed to community interests.

Solar services providers may, in some examples, be managed and operated by a utility, manufacturer, one or more investors, a special purpose entity, or other parties discussed above.

As FIG. 1 illustrates, program 101 includes special purpose entity 158 organized to perform various financial and managerial duties associated with the community power program. These duties may include partially funding the deployment of energy generating equipment on the property of the community member. This may include, for example, directing funds from investors or tranche funds to develop new renewable energy projects. In some examples, special purpose entities may use benefits received in association with existing renewable energy developments to fund new ones. In some examples, special purpose entities may negotiate pricing with manufacturers and provide financing arrangements and manage the interests of investors, such as by providing them with investment structures to invest in community power programs. In many cases, this investment structure may define equity shares in the special purpose entity or an associated separate receiver entity. Special purpose entities may also offer investors a promise to percentage of gains they accumulate.

In some examples, the special purpose entity (or other parties that interface with investors, manufacturers, and/or installers) may set financing arrangements including a tax equity fund that will provide the financing for the energy generating equipment. This fund may provide preferential tax treatment, which generates a benefit that may be directed to the community interest.

In some examples, special purpose entities may provide investment vehicles that attach solar ratings to associated community members. These solar ratings are calculated to numerically express their ability to produce solar power. This solar rating may be useful to determine how to allocate solar energy generating equipment amongst community members who are most able host the equipment. They may additionally or alternatively be used to create tranche funds that may spur more investment through increasing predictability of solar generation revenue. This may ultimately increase the amount of benefit that may be directed to the community interest and raise capital to support the various entities of the community power program. Tranche funds may be structured to allow investors to invest in the community power program at various levels of risk, often defined by the aforementioned solar rating. These tranche funds' return on investment may additionally or alternatively include depreciation as a key component. This depreciation may represent up to 85% of the value of equipment sold under current manufacturers' accelerated cost recovery schedules and allowances.

In some examples, the special purpose entity may perform the primary management duties of the community power program. In some examples these management duties may pertain to the operation of the installation of energy generating equipment and accounting for accrued benefits until they are directed to a community interest. In some examples, special purpose entities may direct benefits to a separate receiver entity, which may then distribute the benefits to a community interest. In some examples, special purpose entities are tasked with administering SPPAs or other agreements. In some examples, special purpose entities may, be wholly or partially owned, managed, or operated by other parties of a community power program, such as solar services providers, separate receiver entities, or utilities.

In some examples, special purpose entities may perform marketing duties on behalf of associated community power programs, thereby allowing potential customers to identify a distinct brand associated with the program.

In some examples, special purpose entities may, through contract, receive benefits, such as renewable energy credits or saleable renewable energy credits, received in exchange for host community members' use of energy generating equipment. The special purpose entity distributes these benefits accrued in the community power program. As will be discussed below, the special purpose entity may direct benefits to community interests, such as separate receiver entities, green energy trusts, or community energy exchange programs, each of which are organized to direct funds to community interests. Energy credits, in particular, may, in some cases, serve as vehicles through which grid energy may be transferred amongst parties. As a result, transferring these benefits allows host community members to provide energy to community interests (to the extent possible on the grid system). In some examples, special purpose entities may be funded by a portion of these same benefits.

In other examples, the special purpose entities may act as the primary interface between host community members and utilities. As previously mentioned, credits, beneficial tax treatment, and other subsidies and economic benefits, may be internalized as a discount of the prices host community members pay for their energy. In some examples, all or a portion of these discounts may be directed to a host community member. Additionally or alternatively, host community members may no longer receive the discounted price of energy; they receive benefits in the form of community interest development rather than an individual financial reward. This encourages community-wide development of energy generating programs that benefit the community as a whole, rather than solely individuals within the community.

In some examples, independent investors may provide tranche funds or tax equity funds structured to develop the community power program or produce benefits that may be contributed to the community interest. In other examples, investors, such as investors 160, may benefit the community power program by providing capital through investing in special purpose entity 158 or associated funds or other investment vehicles.

As FIG. 3 shows, host community member 152 defines a member of a community that has installed energy generating equipment 177 defining solar panels on his property. In some examples, host community members may define individuals, residences, businesses, or other owners of property that are members of an associated community.

In some examples, host community members may use a portion of the energy generated by energy generating equipment hosted on their property to satiate their own electrical consumption, but this is not required. For example, some host community members may define an energy generating facility that lacks significant structure beyond its energy generating equipment. Such examples may direct a portion of energy generated with the energy generating equipment to other community members or to community interest organizations. In some cases, host community members may define generation facilities, such as solar farms, power plants, or other facilities designed to generate electricity. In some such examples, host community members may be geographically distal one or more other community members, particularly in communities not strictly defined by geography.

As FIG. 2 shows, energy generating equipment is deployed on the host community member's property at step 106. Deploying the energy generating equipment on the host community member's property includes purchasing energy generating equipment and installing it on a host's property. In some examples, the host community member may purchase and install equipment on his own or according to agreements with other parties, such as an SPPA. In some cases, separate receiver entities may enter into an SPPA on behalf of hosts, to harness, for the community's benefit, benefits received (along with the per-unit of energy price paid for the power by the host community member) that exceed the cost of the equipment. In some examples, the energy generating equipment may define government-subsidized energy generating equipment. Government-subsidized energy generating equipment defines any energy generating equipment eligible for government-issued benefits, such as solar powered energy generating equipment, wind turbines, or other renewable energy generating equipment.

As FIG. 2 shows, a delivered portion of the energy generated by the energy generating equipment is delivered to the host community member, a receiving community member, or a utility at step 109. FIG. 3 illustrates an example, wherein host community member 152 is able to transmit, through power grid 178, energy to utility 162, a receiving community member 182, and a community interest organization 184 defining a school. In some examples, the host community member may deliver all generated energy to his own property to serve its energy demand. Some energy, however, such as surpluses, may be transmitted to other parties. As FIG. 3 illustrates, host community member 152 may direct, as a benefit, energy delivered to the community interest, either as electricity delivered to a community interest organization via a power grid or as energy credits that may be applied to a community interest's energy bill. For example, host community member 152 may donate a community portion of the energy generated by the energy generating equipment to a community organization, such as community interest organization 184. In some examples, associated community power programs may further direct to community interests a benefit received in response to delivering the community portion. The amount of this benefit may be determined, for example, by measuring the community portion of the energy delivered to the receiving community member from the energy generating equipment. The community portion of the energy may be measured by known metering or net metering methods. In some examples, the community power program may include energy storage equipment, such as batteries, fuel cells, or grid energy storage, to store energy until it is ready to be used by the host community member or other members of the community.

As FIG. 2 shows, the delivered portion of the energy is measured at step 112. This often includes currently understood energy metering techniques. In some examples, a meter, such as one provided by a utility, produces a measurement that reflects the amount of energy was generated by the energy generating equipment and delivered to a destination. In some examples, the measurement may include a representation of energy delivered to the host community member; in other examples, the measurement may include a representation of energy sent through an energy grid to other sources. Some examples may use net metering or other metering techniques, as described above.

As FIG. 2 shows, the amount of benefit received by community power program and/or directed to community interests may be calculated based on the measurement received at step 112.

In some examples, this measurement may reflect the amount of energy generated with the energy generating equipment. In some such examples, the benefits accrued may define transferrable credits that may be donated to community interests to, in effect, provide community interests with a portion of the energy by the host community member. This may be useful to track the amount of energy hosts produce from renewable sources, such as solar panels or wind turbines. In some cases, the hosts or owners of renewable energy generating equipment are entitled to renewable energy credits, or other forms of compensation, based on the measured amount of renewable energy they generate.

Benefits may be initially directed to various parties, based on the terms of a particular community power program. In some examples, the benefits may first be received by the host before being received; in such examples, the host may then direct the benefit to the community interest in compliance with a community power program. In other examples, the benefit may be initially directed to another party to the SPPA, such as a utility, special purpose entity, or solar services provider. In such cases, they may direct the benefit to a community interest, either directly or through a separate receiver entity. In some examples, the benefits may additionally or alternatively be directed to other programs set up to benefit community interests, such as green energy trusts or community energy exchange programs.

In some examples, benefits may define credits or subsidies received from governments or private entities in exchange for producing renewable energy. These credits or subsidies are often transferable, where the receiving party may be able to use them to offset or reduce the cost of their energy generation. These credits and subsidies may also be transferred for cash or other consideration, which may equally serve as a benefit. Examples of credits may include Energy Credits, Energy Share Credits, Renewable Energy Credits, and Net Metering Credits. In some cases, benefits may define government subsidies earned for generating energy with government-subsidized energy generating equipment, such as solar panels or wind turbines.

Indeed, there exist a great variety of benefits that may be directed to a community interest through a community power program. A non-exclusive list of such benefits that may be applicable to various examples is provided below:
Corporate Deductions;
Energy-Efficient Commercial Buildings Tax Deductions;
Corporate Depreciation;
Modified Accelerated Cost-Recovery System and Bonus Depreciation;
Corporate Exemptions;
Residential Energy Conservation Subsidy Exclusions;
Corporate Energy Conservation Subsidy Exclusions;
Business Energy Investment Tax Credits;
Renewable Electricity Production Tax Credit;
Grants supported by Federal Grant Programs;
Tribal Energy Program Grants;
U.S. Department of Treasury Renewable Energy Grants;
USDA supported High Energy Cost Grant Program grants;
USDA supported Rural Energy for America Program grants;
Loans administered by the Federal Loan Program;
Clean Renewable Energy Bonds;
Energy-Efficient Mortgages;
Qualified Energy Conservation Bonds;
Loans administered by U.S. Department of Energy's loan guarantee program;
Performance-based incentives;
Renewable Energy Production Incentives;
Personal Exemptions;
Residential Energy Conservation Subsidy Exclusions;
Personal Tax Credits;
Residential Energy Efficiency Tax Credits; and
Residential Renewable Energy Tax Credits.

In some examples, benefits may include referral fees, such as those earned by hosts, solar services providers, or marketing operations for recruiting new members to participate in the program. In some cases, solar service providers may pay these referral fees, wherein they may be transferred to a community interest, such as through a green energy trust fund.

In some examples, the benefit may not be strictly tied to the amount of energy generated. For example, hosts may often receive benefits, such as favorable tax treatment, energy credits, rebates, remuneration, or other financial incentives, in exchange for installing renewable energy generating equipment. In many cases, these may be earned upon purchasing or installing renewable energy generating equipment. These benefits, like those discussed previously, may be directed to the community interest.

The separate receiver entity is organized to direct benefit to one or more community interests. In many cases, the separate receiver entity is a school, school district, community interest organization, non-profit organization, foundation, charity, or other organization that is well-positioned to direct received benefits to community interests. In many cases, the separate receiver entity may be a non-profit entity. Often, the separate receiver entity defines a business entity, committee, or other organization created solely for an associated community power program formed to manage community members' accrued benefits and ultimately transacts them to community interests. In some examples, this may define a business entity that is organized to accumulate benefits and distribute them to community interests. In some examples, the separate receiver entity may direct funds from the special purpose entity to a green energy trust, general trust, or other organization that is arranged to hold or distribute assets on behalf of the community power program.

In some cases, separate receiver entities manage associated community power programs, and community members participate in community power programs by entering agreements with the separate receiver entities.

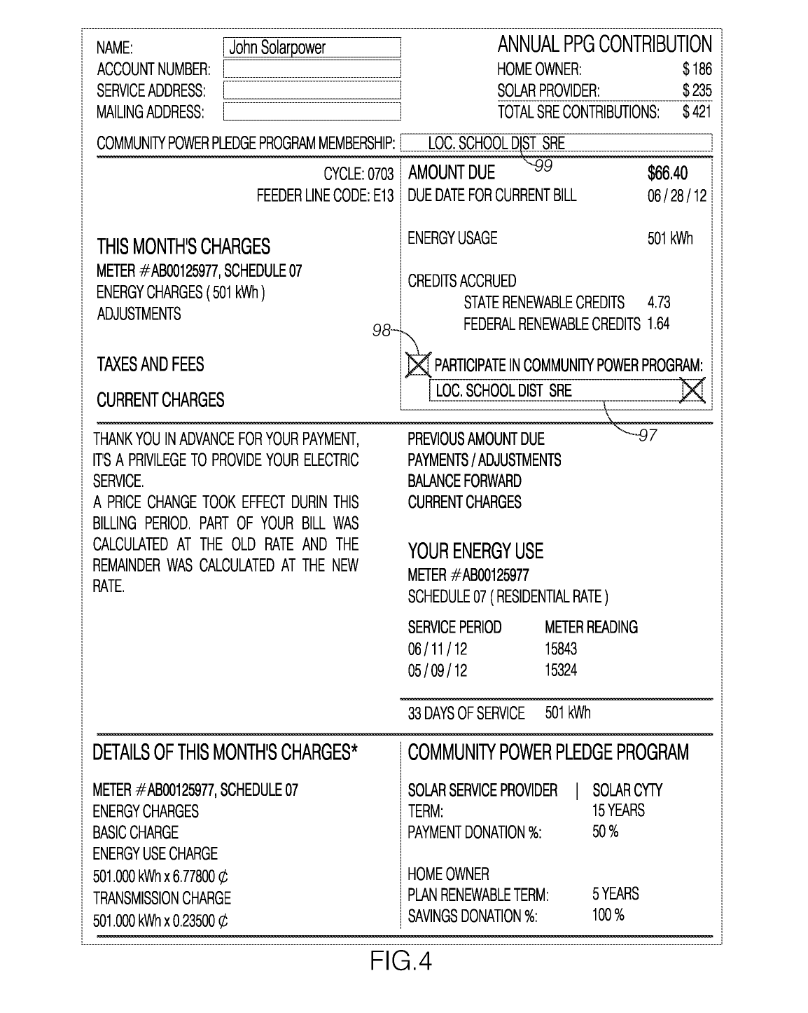

FIG. 4 illustrates one example of a means by which community members may participate in a community power program associated with that community. FIG. 4 illustrates an example form 95 defining a power bill of a member of a community with an established community power program 99, “LOC. SCHOOL DISTRICT SRE,” associated with the community member's school district. As FIG. 4 illustrates, the community member may choose to participate in a community power program from selecting a community power program participation entry 98 and selecting the desired community power program from a community power program list 97. Although list 97 includes only one entry, it may include more if the party receiving the bill is eligible to participate in multiple community power programs. As FIG. 4 illustrates, the community member may be told the amount of renewable energy credits generated over a billing period according to his current energy generation profile.

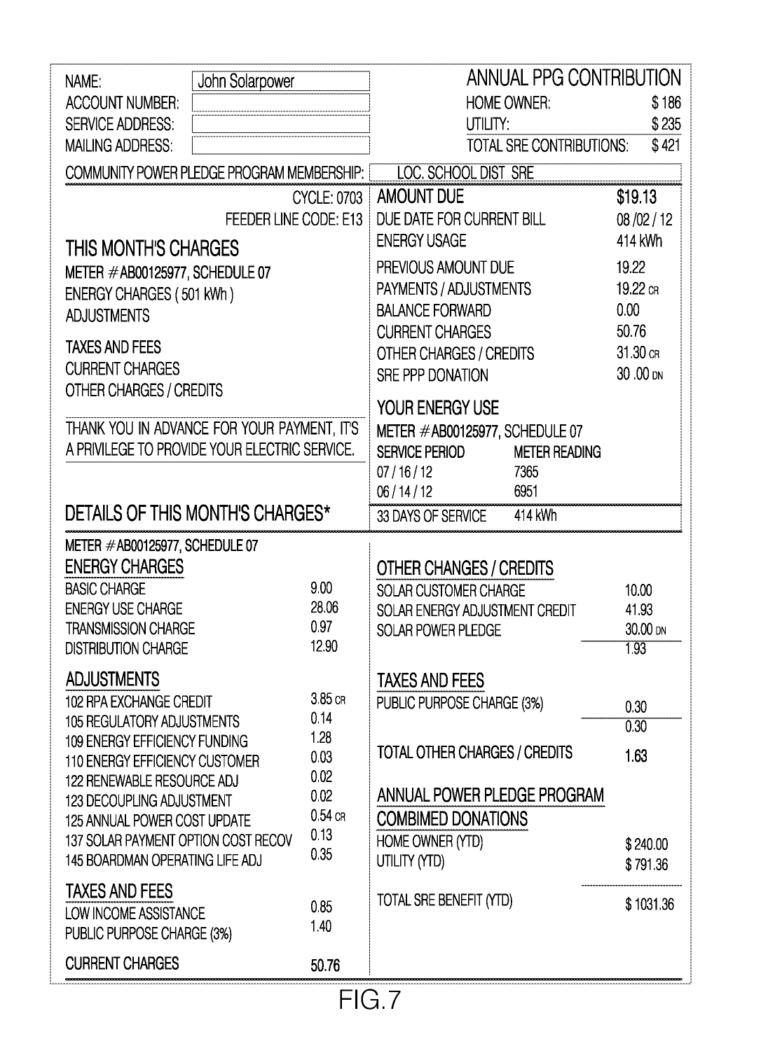

FIG. 7 illustrates another example of a power bill that illustrates how some of the benefits may accrue according to a particular community power program. For example, FIG. 7 includes a section illustrating “ANNUAL POWER PLEDGE PROGRAM COMBINED DONATIONS” that shows the amount donated to the community power program in the given year. Further, FIG. 7 illustrates the amount of benefits directed to a special purpose entity as a result of the participant's participation in the community power program in the “SRE PPP DONATION.” As FIG. 7 illustrates, this represents a portion of the accrued for the use of solar energy on the participant's property; the other benefits may be directed to other entities, such as the special purpose entity, utility, or other interested party, to partially subsidize the community power program.

In some examples, separate receiver entities may define or be integrated with already-established community interest organizations. For example, separate receiver entities may be a school district, individual school, other governmental entity, or other community interest organizations. In some examples, community members may define a collection of residences within a school district. In such examples, school districts may determine how to apply benefits received through community power programs to one or more receiver schools, which may be members of the school district.

In various examples, green energy trusts may be created and managed by special purpose entities or separate receiver entities. Such green energy trusts may be able to receive and hold benefits until separate receiver entities acquire them through a selection or application processes. Green energy trusts may allow benefits to be stored until community interest organizations or separate receiver entities comply with requirements directed by the trust. In some examples (particularly ones wherein community power programs may direct benefits to one or more community interest organizations), green energy trusts may include procedures that govern how money should be directed amongst different community interest organizations or separate receiver entities. In some examples, green energy trusts may have rules that direct that their funds must be directed to a community interest (or, in some cases, a particular separate receiver entity). In some cases, green energy trusts may define organizations organized to receive tax deductible donations.

In some examples, the separate receiver entity may direct benefits to a community energy exchange program, which operates to direct benefits received by hosts (or their agents) in exchange for a portion of the power generated with the energy generating equipment. In some examples, the separate receiver entity may operate the community energy exchange program. In some examples, community energy exchange programs may use energy share credits to reduce school districts' electric bills by donating a portion of the benefits accrued by community power program participants' use of renewable energy generating equipment. In some cases, this may result in a $500,000 (or even greater) discount. In some examples, community energy exchange programs may donate a portion of a benefit received in response to deploying or purchasing renewable energy generating equipment. In some typical cases, $1000 has been seen to be an appropriate value per sale to donate, providing the community interest with a meaningful amount while retaining enough to pay for the equipment and fund administrative costs of community power program parties. In some examples, community energy exchange programs may deploy renewable energy generating equipment at a community interest organization. The community energy exchange program may do this by using some or all of the benefits accrued by host community members. This disclosure contemplates that separate receiver entities, or any other entity performing the duties of a separate receiver entity, may additionally or alternatively perform all of the tasks discussed in association with the community energy exchange corporation. Further, community power programs may, in some examples, operate community energy exchange programs independent of a separate receiver entity.

In some examples, the separate receiver entity may be involved in marketing the community power program through a joint marketing effort with other parties in community power programs. In some examples, schools' booster clubs or parent-teacher organizations may join with special purpose entities, energy providers, or utilities in marketing the community benefits that may be achieved through community members' involvement in community power programs.

Further, separate receiver entities, special purpose entities, or solar services providers may, in some examples, be organized as a non-profit entity. This may allow certain organizations, including government entities, such as schools, to market for clean energy in a way that the schools themselves would not be able to do on their own. By establishing a separate receiver entity, such examples may provide sufficient insulation between the marketing entity and the community interest to allow the community interest to market for the community power program. Certain community interests may, for example, be prohibited from directly marketing for-profit activities. Because the community power program generally, and the separate receiver entity specifically, operate for the community benefit (and may potentially be non-profit entities), non-profit community interests may be able to advertise them directly in a way that they were not previously able. When separate receiver entities, special purpose entities, or solar services providers are organized as non-profit entries, they may be allowed to produce marketing materials that reference the community power program and tout the benefits of community power programs in a way that would not be allowed if for-profit entities were involved. In some examples, this may play out as a cooperative commercial marketing program between schools and separate receiver entities, special purpose entities, or solar services providers. This may, for example, allow schools, school districts, or booster clubs associated with schools to market on behalf of disclosed community power programs and methods.

Marketing materials coming from these specific sources may drive home to consumers the import and community benefit of joining the community power program, thereby increasing participation. The community interests (and associated organizations) may additionally be able to provide direct marketing to members of their community. For example, a school booster organization may be able to market the community power program to the club's members or to members of the school or district they support. The community interests/organizations may, in some examples, accrue referral fees or revenues as a result of their marketing efforts, which may be applied to further support the community interest.

In some examples, non-profit entities may direct money to special purpose entities, who may be able to use the money to market the community power program's benefit to the community. This may assist in allowing non-profit entities market on their behalf in ways that they would not otherwise be able to do.

As FIG. 2 illustrates, a portion of the benefit is distributed to a community interest at step 118. In some examples, benefits accrued by the separate receiver entity are distributed to a community interest; in many cases, this is accomplished by distributing the benefit to one or more community interest organizations. An example of such a community interest is illustrated in FIG. 3 as community interest organization 184 defining a school. In some examples, the benefit may define a government subsidy, and a portion of the government subsidy may be distributed to community interest, substantially similar to other benefits. By directing these benefits to a community interest or entity organized for the community's benefit, the directed benefits are converted to an investment in the community with an ongoing rate of return.

While FIG. 3 illustrates community interest organization 184 as a school, the community interest, in some examples, may define school districts, public buildings, or other public programs or funds (such as those directed toward local parks). In some examples, community interests may define a private charitable causes. In some examples, communities may agree upon to benefit a particular cause or interest that does not directly benefit the community. Such examples may direct funds to charities or other organizations selected by the communities.

In some examples, community power programs directing benefits to community interests may receive compensation, such as tax deductions or credits, in exchange for their charitable contribution of power. Some community power programs may include methods for automatically directing the benefit of this compensation to the community interest.

In some examples, the benefit is contributed to the community interest by a separate receiver entity. In some cases, the separate receiver entity may acquire the benefit and contribute it directly to the community interest. This could occur, for example, when the separate receiver entity receives a credit received in response to operating the energy generating equipment.

In other cases, the separate receiver entity may sell the benefit to a third party (or one of the other participants in the community power program, such as the utility) and direct the proceeds to the community interest.

In some cases, the benefit may be contributed to the community interest by way of one of the other participants of the community power program. For example, the host community member may receive credits for deploying or operating energy generating equipment. The host community member may direct received credits to a special purpose entity, a utility, investors, a solar services provider, or other parties, prior to them ever reaching the separate receiver entity. These other members may sell credits and distribute proceeds as well, as described above. This may be useful, for example, if other participants in community power programs designed to distribute a selected percentage of accrued benefit to the community interest, while using some of the residual benefit to financially assist the program.

In some examples, photovoltaic-based energy generating equipment may be sold and installed on the property of a community member. In some such examples, rather than paying the solar energy payment that normally would go to a solar provider or a financier from the Utility, who measures the generated energy, a portion of the solar payment, the portion predetermined by the community power program, and a portion of savings that result from using solar energy may be distributed to special purposes entities as digitally or monetized credits. These special purpose entities may be organized primarily for the public benefit, in some examples. The special purpose entities may, in return, distribute the funds to separate receiver entities or community interest organizations, such as school endowments. In some cases, these benefits directed by the special purpose entity may be directed in return for cooperative marketing efforts performed by separate receiver entities or community interest organizations.

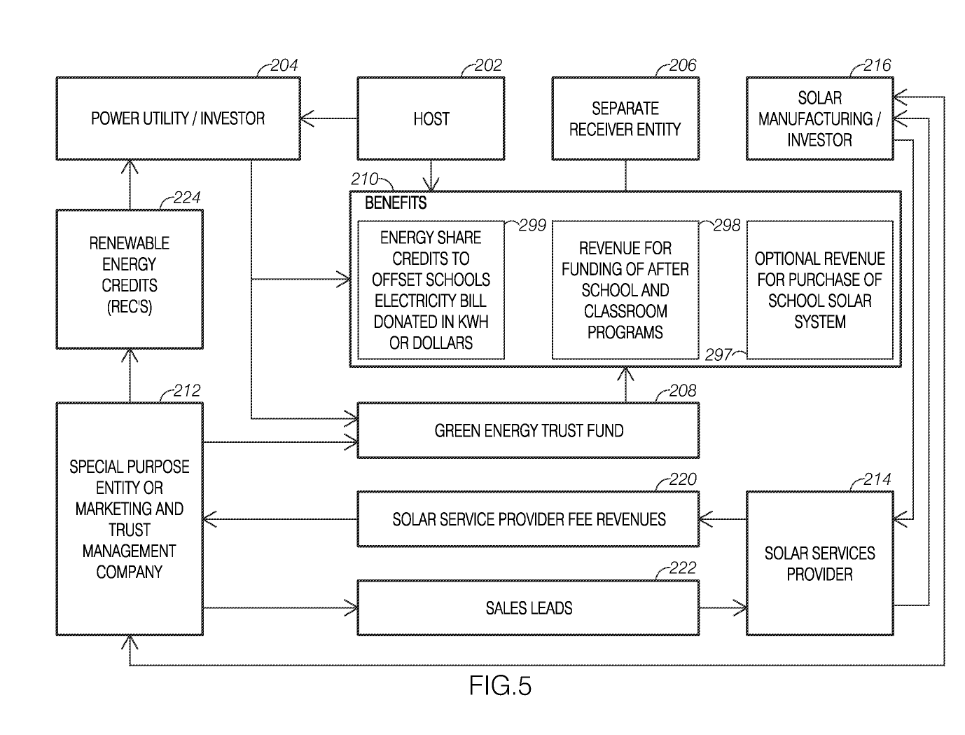

With reference to FIG. 5, a second example of community power program for allocating benefits received in response to generating energy within a community to a community interest, program 200, will now be described. As FIG. 5 illustrates, program 200 includes many features similar or identical to method 100. For the sake of brevity and clarity, some of these common features may not be described in detail. Rather, the discussion of program 200 may focus on additional or alternative features of the method shown in FIG. 5.

As FIG. 5 illustrates, program 200 includes a host 202, a utility 204, a separate receiver entity 206, a green energy trust fund 208, a special purpose entity 212, a solar services provider 214, and solar manufacturers and investors 216, and a community interest organization 218.

Host 202 hosts renewable energy generating equipment on his property, which generate benefits that may ultimately be directed to community interest organization 218. In some examples, host 202's use of renewable energy generating equipment generates digitized or monetized “energy share credits” measured using standard net metering. In other examples, host 202 generates solar renewable energy credits. These credits may be used to re-distributed or aggregated energy in the form of “offsets” that may be applied to reduce a party's energy cost.

Utility 204 may, in some examples, provide grid power to host 202 to supplement the host or home owners' own photovoltaic solar production. Utility 204 may also, in some examples, perform the net metering and redistribution of credits, often to separate receiver entities. Some utilities may purchase additional or alternative credits from solar services providers or special purpose entities. In some examples, utilities may provide funding as an investor. In various examples, utilities may participate in revenue sharing with one or more other parties, which may allow the parties to more efficiently cooperate in coordinating associated community power programs.

Solar manufacturers and investors 216 provide funding and renewable energy generating equipment to program 200. Investors and manufacturers to achieve more mobile and flexible profit margins through efficiencies and economies of scale, tax deductible power donations, more effective use of accelerated depreciation, and power utility subsidies. These parties may, in some examples, achieve a higher per unit sale price through a unique value proposition of a low to no cost solar system to host 202 and the energy it provides to host 202 and separate receiver entity 206. As an example, solar panel producers may supply a tranche tax equity fund to provide funding to solar providers. This would allow the return on investment to be leveraged primarily by depreciation and the revenues received from the power generation. Additionally or alternatively, tax deductible energy share credit donations and government or utility subsidies may augment the return on investment. In some examples, solar manufacturers and investors 216 and utility 204 may participate in revenue sharing with special purpose entity 212. This may include profit margin balancing to correct inequities between manufacturing partners or tranche funds and special purpose entities. Such revenue sharing may additionally or alternatively include solar service providers as a participant.

In some examples, the adjusting of the value proposition may result in increasing the marginal value of installing renewable energy generating equipment, thereby making the prospect of installing renewable energy generating equipment more attractive to members of the community. As a corollary, of course, the de facto cost of installing renewable energy generating equipment may go down, and members of the community, including residence owners and businesses, may install energy generating equipment on their property at a cost that reflects the adjusted value proposition. In some cases, adjusting this value proposition may create a platform for smart grid investment at a local level. This may result, in part, due to the likelihood of increasing the density of installations that will ultimately result from the adjusted value proposition.

Solar services provider 214 acts as a provider of photovoltaic systems for residential properties. Solar services provider 214 receives funds from solar manufacturers and investors 216, such as from a tranche tax equity fund. As FIG. 5 illustrates, solar services provider 214 directs solar service fee revenues 220 to special purpose entity 212. In some examples, solar service fee revenues 220 may include referral fee revenues acquired from unit sales of residential solar systems. In some examples, solar service fee revenues 220 may include lead generation revenue or “order processing” fee revenues. In some examples, solar service fee revenues 220 may include program service area participation fee revenues.

Special purpose entity 212 performs many of the administrative tasks associated with program 200. This may include managing operational, marketing, and distribution revenues. These revenues may be generated in two phases. A first phase may include lead generation, solar system sales, referral fee processing, school sports wear sponsoring, and governmental/utility grants. A second phase may include revenues from solar system energy, solar service providers, receipt of renewable energy credits accrued from generating energy, a tax equity tranche fund (such as those previously mentioned), solar panel manufacturing, and government sponsorship.

As FIG. 5 illustrates, separate receiver entity 206 may generate sales leads 222 and direct them to solar services provider 214. These sales leads may include information about potential customers or orders to “process” one or more approved solar providers in a targeted service area, such as a school district.

Green energy trust fund 208 provides tax deductible revenue distributions. These funds may be applied for by schools in need of budget assistance in the form of electrical energy through an “energy share credit” program or other similar program. These funds may also include actual funds realized through the sale of solar systems in a targeted service area.

As FIG. 5 shows, special purpose entity 212 may also provide a home owner rebate 224 that benefits one or more hosts. In some examples, this may amount as much as 20% of hosts' energy bill. This may amount as much as $5,434 over the life span of an example system installed by an example host.

One or more parties may direct benefits, such as those included in benefits 210 to separate receiver entity 206. These benefits may include energy share credits 299, used to offset schools' electricity bill and donated in kWh or Dollars, program revenue 298, for funding of after-school, classroom, or other school sponsored programs, and/or purchasing revenue 297, for purchasing of renewable energy generating equipment to be installed at schools.

Separate receiver entity 206 is organized to direct benefits, such as benefits 210, to community interests and community interest organizations. For example, separate receiver entity 206 may direct benefits to schools or school districts to benefit the communities in which they are a part. Separate receiver entity 206 may, in other examples, direct benefits to governmental entities, such as governments, commissions, or funds that support community projects. Separate receiver entity 206 may also, in some examples, private entities that support development in the community, such as charitable organizations. These benefits may be used by community interest organizations, for example, to offset a portion of their energy bills, support that organization's programs (such as after-school or classroom programs, in the case of schools), or develop renewable energy projects on their property.

Separate receiver entity 206 may additionally administer a community energy exchange program to distribute benefits to community interests and/or community interest organizations. This community energy exchange program may, for example, include an energy share credit program that offsets electric bills of community interest organizations with credits donated by hosts (or other parties of program 200). These credits may, in some examples, correspond to a portion of the energy generated by hosts and donated to separate receiver entity 206 for the community benefit. The community energy exchange program may additionally or alternatively include benefits received in connection with the sale of energy generating equipment to hosts. This may include benefits received in connection with the sale or a donation made at the time of sale, either by host or by another party on behalf of host. In other examples, community power programs may direct benefits that may be used by community interest organizations to develop renewable energy generation projects, such as installing photovoltaic panels, on community interest organizations' property.

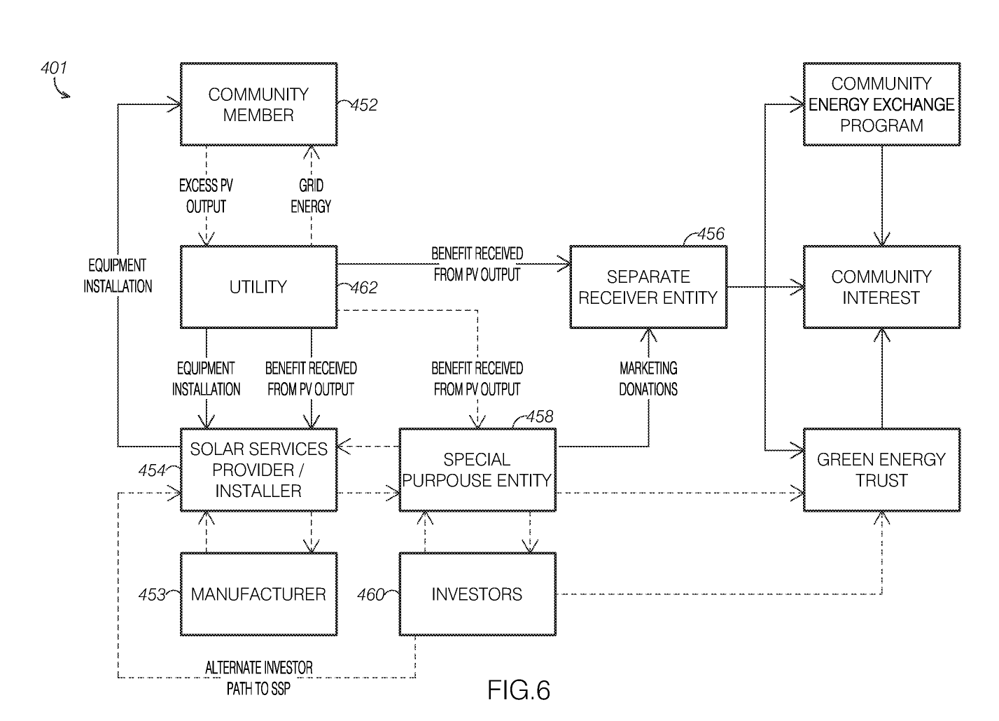

FIG. 6 illustrates an additional or alternative example of an organizational scheme for a community power program. The example illustrated in FIG. 6 includes many features that are substantially similar to many features in the examples shown in FIGS. 1 and 5. As a result, each and every feature of FIG. 6 will not be described. Rather, differences between FIG. 6 and previous examples will be discussed.

As FIG. 6 illustrates, the roles of utility 462 and community member 452 have been adjusted slightly. In the example shown in FIG. 6, utility 462 receives grid energy, which may include photovoltaic output that exceeds the host community member's energy consumption, until directing them to a separate receiver entity. Further, utility 462 may direct grid energy to community member 452 that helps satiate the community member's energy consumption.

Utility 462 may additionally or alternatively direct benefits to a solar services provider 454 and/or a special purpose entity 458. These two parties may use these funds to administer the community power program. Associated expense may include, for example, marketing the program, running the services necessary to track the amount of benefits accrued, distributing funds to investors, etc. Solar services provider 454 will often install the equipment on community member 452's property; in many cases, this will be either funded or subsidized by benefits accrued from the community power program.

FIG. 6 illustrates marketing donations being directed to separate receiver entity 456. As discussed above, separate receiver entities are often non-profit organizations. As a result, it may not be possible for separate receiver entities to market on behalf of each and every member community power programs. Separate receiver entity 456, however, receives, as a part of the benefits received in the community power program, a donation that may be applied for marketing purposes. Using this marketing donation, separate receiver entity 456 may be able to market the community power program without improperly marketing on behalf of other interested entities. As a result, separate receiver entities may apply a portion of benefits accrued as a result of community member 452's participation in the community power program to the development of marketing materials that can be distributed to additional or alternative community members.

Like in past examples, certain parties in the example shown in FIG. 6 may vertically integrate to make community power programs more economically efficient. In some examples, solar services providers, installers, special purpose entities, and utilities may be vertically integrated; indeed, this is how many community power programs will operate. In such examples, the single vertically integrated entity may administrate one or more community power programs, provide the community member with energy generating equipment, and direct benefits to a separate receiver entity. This separate receiver entity may then use the funds for its own purposes or further distribute it to additional or alternative interests that benefit the community as a whole.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method of allocating benefits received in response to generating energy within a community to a community interest, comprising:
deploying energy generating equipment on property of a host community member;
delivering a delivered portion of the energy generated by the energy generating equipment to the host community member, a receiving community member, or a power grid;
measuring the delivered portion of the energy to produce a measurement;
receiving a benefit associated with purchasing the energy generating equipment or generating energy with the energy generating equipment, the benefit defining an amount calculated based on the measurement; and
distributing a portion of the benefit to the community interest.

2. The method of claim 1, wherein measuring the delivered portion of the energy includes metering the delivered portion of the energy with metering equipment.

3. The method of claim 1, further comprising communicating the benefit to a community accessible location.

4. The method of claim 1, wherein delivering the delivered portion of the energy includes powering an electrical device on the property of the host community member; and
receiving a benefit includes receiving a benefit associated with the energy used to power the electrical device on the property of the host community member.

5. The method of claim 1, further comprising deploying renewable energy generating equipment on one or more supplemental host community members' property in response to adjusting a value proposition by distributing a portion of the benefit to the community interest or a community interest organization.

6. The method of claim 5, wherein adjusting the value proposition includes directing a portion of the benefit to the community to increase the marginal value of installing renewable energy generating equipment on the property of the host community member.

7. The method of claim 5, wherein energy generating equipment is installed on the property of a second community member at a cost that reflects the adjusted value proposition.

8. The method of claim 7, wherein the second community member is a business.

9. The method of claim 1, wherein distributing the portion of the benefit to the community interest includes distributing an energy credit to a community interest organization.

10. The method of claim 1, further comprising distributing a portion of the benefit to a special purpose entity interfaced with investors, the special purpose entity established to manage interests of the investors and to partially fund deploying the energy generating equipment on the property of the community member.

11. The method of claim 1, wherein the benefit includes a monetary payment received in exchange for delivering energy generated by the energy generating to the power grid.

12. The method of claim 1, wherein the benefit defines a government subsidy received for deploying government-subsidized energy generating equipment.

13. The method of claim 1, wherein the energy generating equipment includes a photovoltaic cell.

14. The method of claim 1, wherein:
the community defines a collection of residences within a school district including one or more local schools; and
directing the portion of the benefit includes directing the portion of the benefit the benefit to one or more receiver schools in the school district associated with the community.

15. The method of claim 1, wherein receiving the benefit includes establishing an entity to manage the benefit until the benefit is distributed to the community interest.

16. The method of claim 15, wherein the entity directs a portion of the benefit to a green energy trust, a general trust, a foundation, or a non-profit organization.

17. The method of claim 15, wherein the entity directs a portion of the energy to a community energy exchange program.

18. The method of claim 1, wherein the benefit includes a credit selected from the group consisting of an energy credit, an energy share credit, and a solar renewable energy credit.

19. The method of claim 18, wherein:
distributing a portion of the benefit to the community includes transferring the credit to a community interest, wherein the community interest uses the credit to reduce its energy expenditures.

20. The method of claim 18, further comprising applying the credit to the community interest organization to offset all or a portion of the community interest organization's energy consumption.

21. The method of claim 1, wherein measuring the delivered portion of the energy includes:
installing a meter on or near the property of the community member, wherein the meter is:
configured to read the energy generated by the energy generating equipment; and
in data communication with a utility.

22. The method of claim 1, wherein deploying energy generating equipment on the property of the community member includes:
directing funds from a tranche fund or a tax equity fund to a solar services provider;
instructing the solar services provider to install the energy generating equipment; and
receiving funds from the solar services provider as a commission or referral fee.

23. The method of claim 1, wherein distributing the portion of the benefit includes directing a portion of a commission or a referral fee to the community interest.

24. A method of effectively powering community interest organizations by directing accrued benefits earned by host community members to the community interest organizations, the method comprising:
deploying energy generating equipment on property of a community member;
donating a community portion of energy generated by the energy generating equipment to a community interest organization; and
measuring the community portion of the energy delivered to the receiving community member from the energy generating equipment.

25. The method of claim 24, wherein the community potion of the energy is delivered in the form of an energy credit.

26. The method of claim 24, further comprising:
providing energy storage equipment; and
storing a portion of the special purpose portion of the energy with the storage equipment prior to delivering the community portion to the separate receiver entity.

27. A method of allocating benefits received in response to generating energy within a community to a community interest, comprising:
deploying energy generating equipment on property of a community member, the energy generating equipment capable of delivering a delivered portion of the energy generated by the energy generating equipment to a utility;
measuring the delivered portion of the energy delivered to the utility from the energy generating equipment;
receiving a government subsidy in response to deploying the energy generating equipment; and
directing at least a portion of the government subsidy to the community interest.

28. The method of claim 27, wherein directing at least a portion of the government subsidy to the community includes directing at least a portion of government subsidy to an entity organized to distribute benefits to a plurality of community interest organizations in the host community.

29. A method of allocating benefits received in response to generating energy within a community to a community interest, comprising:
deploying energy generating equipment on property of a host community member;
receiving a benefit associated with the use of the energy generating equipment;
distributing a portion of the benefit to the community interest, the community interest defining a non-profit entity; and
delivering from the non-profit entity marketing materials that reference the community power program.

30. A method of allocating benefits received in response to generating energy within a community to a community interest, comprising:
providing a form to a community member of the community, wherein:
the community member's energy consumption has been at least partially satisfied through renewable energy that produces a benefit; and
the form includes a community power program participation entry that allows the community member to select to participate in the community power program; and
directing a portion of the benefit to the community interest in response to the community member selecting to participate in the community power program.
